(19) United States
(12) Patent Application Publication
(10) Pub. No.: US 2011/0134881 A1
(43) Pub. Date: Jun. 9, 2011

(54) Method for handling hand off of a mobile device using reverse link quality measurements as trigger

(75) Inventors: Susan Wu Sanders, Bridewater, NJ (US); Qi Bi, Morris, NJ (US); Liwa Wang, Morris, NJ (US); Devesh Patel, Somerset, NJ (US); Bee Yun Yu, Morris, NJ (US); Yang Yang, Morris, NJ (US)

(73) Assignee: Alcatel-Lucent USA Inc.

(21) Appl. No.: 12/654,028

(22) Filed: Dec. 8, 2009

(51) Int. Cl. H04W 36/00

(52) U.S. Cl. 370/331

(57) ABSTRACT

In one embodiment a first comparison result is determined based on a link quality metric and a first threshold value. Based on the first comparison result, a second base station is selected, and the mobile device is instructed to switch from communicating wirelessly with the first base station to communicating wirelessly with the second base station

### BACKGROUND OF THE INVENTION

1. Field

Example embodiments of the present invention relate generally to wireless networks and handling hand off operations.

2. Description of Related Art

Wireless networks provide wireless communication for mobile devices via carriers supported by base stations. Each base station in a wireless network has an associated coverage area. As a mobile device reaches the edge of the coverage area of a base station the mobile device is communicating with, the quality of the wireless link between the base station and the mobile device may become weaker resulting in degraded service or even a dropped call for a user of the mobile device. Other causes of a weakening link between a mobile device and a base station may include congestion caused by a high amount of traffic being handled by the base station.

In order to prevent a prolonged instances of degraded service for users of mobile devices a wireless network may control a mobile device having a weak link to start communicating with a new base station. The process of controlling a mobile device to switch from communicating with a first base station to communicating with a new base station is referred to as a hand off operation. Wireless networks include network components capable of monitoring the quality of a link between a base station and a mobile device. The link through which data passes from a base station to a mobile device is referred to as the forward link, and the link through which data passes from a mobile device to a base station is referred to as the reverse link. If the wireless network detects a drop in the quality of the forward link between a base station and a mobile device, the wireless network may trigger a hand off operation for the mobile device.

### SUMMARY OF THE INVENTION

According to one embodiment, a method of handling handoff of a mobile device includes generating a first link quality metric based on a reverse link between the mobile and a first base station. The mobile device is in wireless communication with the first base station. A first comparison result is determined based on the link quality metric and a first threshold value. Based on the first comparison result, a second base station is selected, and the mobile device is instructed to switch from communicating wirelessly with the first base station to communicating wirelessly with the second base station.

According to one embodiment, a method of handling handoff of a mobile device includes communicating wirelessly with a first base station and receiving instructions to switch from communicating wirelessly with the first base station to communicating wirelessly with a second base station. The instructions are based on a link quality of a reverse link between the mobile and the first base station.

### BRIEF DESCRIPTION OF THE DRAWINGS

Example embodiments of the present invention will become more fully understood from the detailed description provided below and the accompanying drawings, wherein like elements are represented by like reference numerals, which are given by way of illustration only and thus are not limiting of the present invention and wherein:

FIG. 1 is a diagram illustrating a wireless system 100 in accordance with an embodiment of the present invention.

FIG. 2 is a flow diagram illustrating a method of handling a mobile assisted inter frequency hand off (MAIFHO) from the viewpoint of one or more network components in accordance with an embodiment of the present invention.

FIG. 3 is a flow diagram illustrating a method of handling a MAIFHO from the viewpoint of a mobile device in accordance with an embodiment of the present invention.

FIG. 4 is a flow diagram illustrating a method of handling an inter frequency direct hand off (DHO) from the viewpoint of one or more network components in accordance with an embodiment of the present invention.

FIG. 5 is a flow diagram illustrating a method of handling an inter frequency DHO from the viewpoint of a mobile device in accordance with an embodiment of the present invention.

FIG. 6 is a diagram illustrating a wireless system 200 in accordance with an embodiment of the present invention.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, the term “mobile device” may be considered synonymous to, and may hereafter be occasionally referred to, as a mobile device, mobile station, mobile user, user equipment (UE), subscriber, user, remote station, access terminal, receiver, etc., and may describe a remote user of wireless resources in a wireless communication network. The term “base station” may be considered synonymous to and/or referred to as a base transceiver station (BTS), NodeB, extended Node B, femto cell, access point, etc. and may describe equipment that provides the radio baseband functions for data and/or voice connectivity between a network and one or more users.

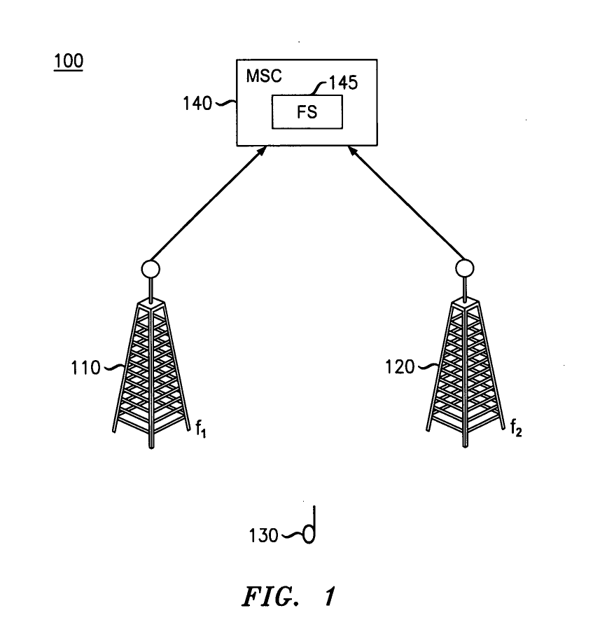

FIG. 1 illustrates a portion of a wireless system 100. Wireless system 100 includes a mobile switching center (MSC) 140, a first base station (BS) 110, a second BS 120 and a mobile device 130. The wireless system 100 may follow, for example, the CDMA2000 protocol.

The first BS 110 is connected to the MSC 140 via a wired or wireless connection. The first BS 110 communicates wirelessly with mobile devices in wireless network 100 using a carrier signal of a first frequency f1. The carrier signal of the first frequency f1 supports wireless communication between the first BS 110 and mobile devices in wireless system 100 that are within range of the first BS 110. The first BS 110 may forward data received from mobile devices to the MSC 140 in the form of data frames. Though wireless system 100 is illustrated as including only one BS communicating wirelessly with mobile devices using the first frequency f1, wireless system 100 may include any number of BSs using the first frequency f1.

The second BS 120 is connected to the MSC 140 via a wired or wireless connection. The second BS 120 communicates wirelessly with mobile devices in wireless network 100 using a carrier signal of a second frequency f2. The carrier signal of the second frequency P2 supports wireless communication between the second BS 120 and mobile devices in wireless system 100 that are within range of the second BS 120. The second BS 120 may forward data received from mobile devices to the MSC 140 in the form of data frames. Though wireless system 100 is illustrated as including only one BS communicating wirelessly with mobile devices using the second frequency f2, wireless system 100 may include any number of BSs operating using a carrier signal of a second frequency f2.

Further, though, for the purpose of clarity, wireless system 100 is discussed with reference to BSs having carrier signals of only two frequencies, first frequency f1 and second frequency f2, wireless system 100 may include BSs having carrier signals of any number of frequencies.

Though not illustrated, the connections between the first BS 110 and the MSC 140, and the second BS 120 and MSC 140, respectively, may include any number of intermediate network elements including, for example, one or more radio network controllers (RNCs).

The MSC 140 handles setting up and disconnecting calls of the mobile devices in wireless network 100. The MSC 140 is connected to a public switched telephone network (PSTN) (not pictured). Though the MSC 140 is illustrated as being connected to only two BSs, the first BS 110 and second BS 120, the MSC 140 may be connected to any number of BSs. The MSC 140 provides a connection between the mobile devices in wireless communication with the BSs connected to the MSC 140 and the PTSN. The MSC 140 also includes a frame selector 145. Data received by the MSC 140 from wireless devices may be processed by the frame selector 145 before being forwarded to the PSTN. The operation of the frame selector 145 will be discussed in greater detail below.

The MSC 140 is capable of handling inter frequency hand offs of mobile devices between different BSs connected to the MSC 140. In an inter frequency hand off operation, in addition to switching from communicating with one BS to communicating with another BS, a mobile device being handed off also switches the frequency the mobile device is using to send and receive data.

The MSC 140 is also capable of using the frame selector 145 to handle soft handoff operations. In a soft handoff operation, a mobile device being handed off may be in simultaneous communication with multiple BSs each using the same frequency. For example, if the mobile device 130 is within range of a plurality of BSs connected to the MSC 140, each of which provides wireless communication for the mobile device 130 using the same frequency (e.g., the first frequency f1), in a soft handoff operation the mobile device 130 may communicate with two or more of the plurality of BSs simultaneously by sending the same data to each using the first frequency f1. Each of the BSs that are in simultaneous wireless communication with mobile device 130 may then forward the data received from the mobile device 130 to the MSC 140 in the form of duplicate data frames. In this case, each of the BSs that are in simultaneous communication with the mobile device 130 sends data frames representing the same data to the MSC 140. Accordingly, the MSC 140 receives duplicate data frames representing the data sent by the mobile device 130. The frame selector 145 in the MSC 140 then receives the duplicate data frames and selects the best data frame for further processing and forwarding to the PSTN based on the relative quality of each of the duplicate frames.

The wireless link that data travels through from a BS, for example first BS 110, to a mobile device, for example mobile device 130, is referred to as the forward link. The wireless link that data travels through from a mobile device, for example mobile device 130, to a BS, for example first BS 110, is referred to as the reverse link. The MSC 140 may include hardware and/or software capable of monitoring a link quality of the forward link. The MSC 140 may use link quality information associated with the forward link in order to determine when to instruct a mobile device to initiate an inter frequency hand-off operation by switching from communicating with one BS to communicating with another BS.

In a conventional wireless network, only quality measurements associated with the forward link are used to determine whether or not to initiate a hand off operation. However, it is possible for the quality of the reverse link to become weak while the quality of the forward link maintains acceptable levels. One reason for this is that BSs use a larger amount of power to transmit signals via the forward link than mobile devices use to transmit data via the reverse link. As another example, it is possible to experience high interference on the reverse link while experiencing relatively low interference on the forward link. Weak quality levels in the reverse link can result in degraded service for the user of a mobile device or even dropped calls. In a situation where a quality of the reverse link degrades while a quality of the forward link does not, in a conventional wireless network, a hand off operation may not be triggered even though the quality of service experienced by the user of the mobile device is degraded. To address this issue, according to the present invention, the MSC 140 is capable of using quality values associated with the reverse link in determining whether or not to initiate a hand off operation.

The MSC 140 may include hardware and/or software capable of monitoring a link quality of the reverse link. The MSC 140 may include hardware and/or software capable of calculating a reverse frame error rate (RFER) associated with data frames traveling over reverse links between mobile devices and BSs connected to the MSC 140. If a soft hand off operation is being carried out in which plural duplicate frames are being received from two or more BSs communicating with a wireless device simultaneously, the MSC 140 is capable of calculating the RFER on the basis of the data frames, from among the plural duplicate frames, selected by the frame selector 145 for further processing. This value will be referred to as the after frame selection RFER (AFSRFER). The MSC 140 may use link quality information associated with the reverse link in order to determine when to instruct a mobile device to initiate an inter frequency hand-off operation by switching from communicating with one BS to communicating with another BS.

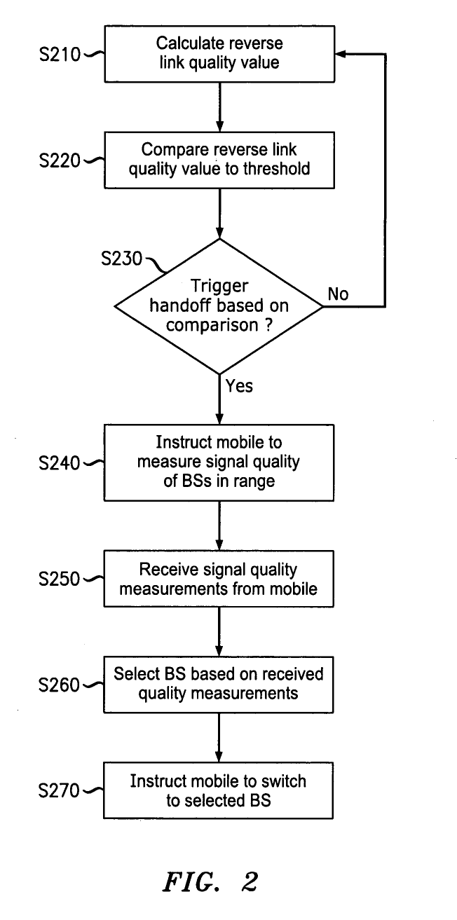

For example, if the mobile device 130 is in wireless communication with the first BS 110 using the carrier of the first frequency f1 and the MSC 140 detects a reduction in the link quality of the reverse link between the mobile device 130 and the first BS 110, the MSC 140 may instruct the mobile device 130 to switch from communicating wirelessly with the first BS 110 using the carrier of the first frequency f1 to communicating with another BS using a carrier of a different frequency, for example the second BS 120 which uses the carrier of the second frequency f2. This process will be discussed in greater detail below with reference to FIGS. 2-5.

The MSC 140 may determine whether to initiate a hand-off operation for a mobile device using link quality information associated with the reverse link in addition to link quality information associated with the forward link. Alternatively, the MSC 140 may determine whether to initiate a hand-off operation for a mobile device using only link quality information associated with the reverse link.

Wireless network 100 supports at least two types of inter frequency hand off operations: mobile assisted inter frequency hand off (MAIFHO) and direct hand off (DHO).

For supporting MAIFHO, the mobile device 130 may include hardware and/or software enabling the mobile device 130 to make link quality measurements for BSs within range of the mobile device 130.

For supporting DHO, the MSC 140 may include hardware and/or software enabling the MSC 140 to store information, for example a table or database, associated with BSs within wireless network 100 including the frequencies of the carriers supported by the BSs and the geographical locations of the BSs.

Methods for triggering MAIFHOs and DHOs based on the link quality of the reverse link will now be discussed.

### Handling a MAIFHO

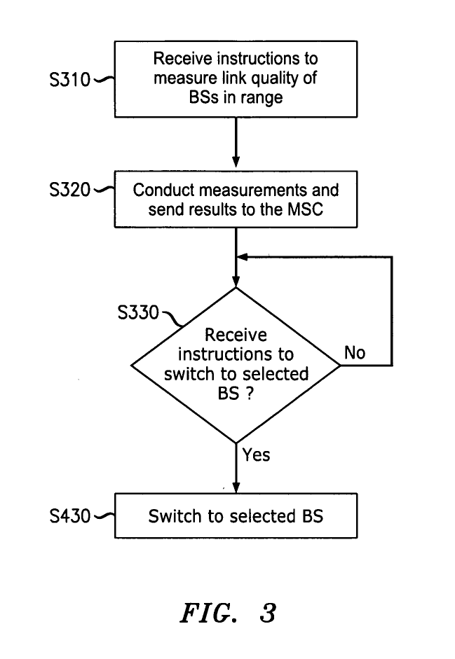

Methods for using reverse link quality measurements as a trigger for a MAIFHO will now be discussed with reference to FIGS. 1, 2 and 3 using an example scenario in which the mobile device 130 transitions from communicating wirelessly with the first BS 110 using the first frequency f1 to communicating wirelessly with the second BS 120 using the second frequency f2, in FIG. 1. The example scenario mentioned above will first be discussed from the point of view of a network component with reference to FIG. 2. The example scenario mentioned above will then be explained from the point of view of a mobile device with reference to FIG. 3.

Referring to FIG. 1, the mobile device 130 has been in wireless communication with the first BS 110 and sending data to the first BS 110 via a reverse link between the mobile device 130 and the first BS 110 using the carrier signal of the first frequency f1. The BS 110 has been forwarding the data received from the mobile device 130 to the MSC 140 in the form of data frames.

FIG. 2 is a flow diagram illustrating a method of handling a MAIFHO from the viewpoint of one or more network components, such as the MSC 140. Referring to FIG. 2, in step S210 a reverse link quality value is calculated. The MSC 140 calculates a link quality value of the reverse link between the mobile 130 and the first BS 110. The link quality of the reverse link will be referred to as the reverse link quality value. For example, the MSC 140 can calculate the RFER based on data frames received by the MSC 140 from the first BS 110 as the reverse link quality value. The MSC 140 may also calculate the AFSRFER based on the data frames selected by the frame selector 105 in the MSC 140 as the reverse link quality value. The MSC 140 may also calculate the average RFER or AFSRFER over a moving time window, for example 100 ms, as the reverse link quality value. Though the MSC 140 is described above as measuring the RFER or AFSRFER as the reverse link quality value, the MSC 140 can measure any known link quality metric associated with the reverse link as the reverse link quality value.

In step S220 the MSC 140 compares the reverse link quality value measured in step S210 to a threshold value. If the measured reverse link quality value is an RFER or an average RFER, the threshold value is also an RFER, for example an RFER of 35%. The MSC 140 then generates a comparison result based on whether or not the measured reverse link quality exceeds the threshold value.

In step S230, based on the comparison result generated in step S220, the MSC 140 decides whether to trigger an inter frequency hand off operation for the mobile device 130. For example, the MSC 140 may decide to trigger the hand off operation if the comparison result indicates that the average RFER exceeds the threshold RFER. As another example, the MSC 140 may decide to trigger the hand off operation if the comparison result indicates that the average RFER has exceeded the threshold RFER for more than a threshold period of time, for example 10s. If, based on the comparison result generated in step S220, the MSC 140 decides not to trigger the hand off operation, the method returns to step S210 and the MSC 140 continues to monitor the reverse link quality. If, based on the comparison result generated in step S220, the MSC 140 decides to trigger the hand off operation, the method proceeds to step S240. Though, for the purpose of simplicity, the process for triggering the inter frequency hand off operation is discussed above with reference only to the average RFER as the reverse link quality value, it will be understood that the same process may be implemented using any measured reverse link quality value including the average AFSRFER.

In step S240 the MSC 140 instructs the mobile device, via the first BS 110, to conduct link quality measurements for BSs within range of the mobile device 130 using a frequency other than the frequency the mobile device 130 is currently using. For example, the MSC 140 may instruct the mobile device 130 to take link quality measurements for BSs within range of the mobile device 130 that use the second frequency f2. The mobile station 130 then reports the link quality measurements via the first BS 110 using the current frequency f1.

In step S250 the MSC 140 receives link quality measurements from the mobile device 130. For example, the MSC 140 may receive from the mobile device 130 link quality measurements of all BSs within range of the mobile device 130 that use the second frequency f2. The received link quality measurements may include measurements based on a forward link. As is stated above, the MSC 140 receives the link quality measurements from the mobile device 130 via the first BS 110.

In step S260 the MSC 140 selects a BS based on the forward link quality measurements received from the mobile device 130 in step S250. The MSC 140 may select the BS associated with the highest link quality value measured by the mobile device 130 on the second frequency f2. For example, the MSC 140 may select the second BS 120 as the BS using the second frequency f2 that has the highest link quality as measured by the mobile device 130.

In step S270 the MSC 140 instructs the mobile device 130 to switch to the selected BS. For example, if the second BS 120 is the BS selected in step S260, the MSC 140 instructs the mobile device 130 to complete the MAIFHO operation by discontinuing communicating wirelessly with the first BS 110 using the first frequency f1, and beginning communicating wirelessly with the second BS 120 using the second frequency f2. The MSC 140 may use any know method for instructing the mobile device 130 to complete a hand off operation between the first BS 110 and the second BS 120.

FIG. 3 is a flow diagram illustrating a method of handling a MAIFHO from the viewpoint of a mobile device. Referring to FIG. 3, in step S310, the mobile device 130 receives instructions to measure forward link quality of BSs within range of the mobile device 130 with respect to a frequency other than the first frequency f1, for example the second frequency f2.

In step S320 the mobile device conducts link quality measurements for BSs within range of the mobile device 130 using a frequency other than the first frequency f1, for example the second frequency 12, and sends the measurements to the MSC 120 via the first BS 110.

In step S330 the mobile device 130 decides whether instructions to switch from communicating with the first BS 110 using the first frequency f1 to communicating with the a BS selected by the MSC 140 have been received from the MSC 140. If instructions have not been received, the mobile device remains at step S330 and continues to wait for instructions. If instructions have been received, the mobile device proceeds to step S340. The BS selected by the MSC 140 may be the BS associated with highest link quality measurements of the link quality measurements sent by the mobile device 130 in step S320, for example the second BS 120.

In step S340 the mobile device 130 discontinues communicating with the first BS 110 using the first frequency f1 and begins communicating with the a BS selected by the MSC 140, for example the second BS 120, completing the MAIFHO operation.

### Handling a DHO

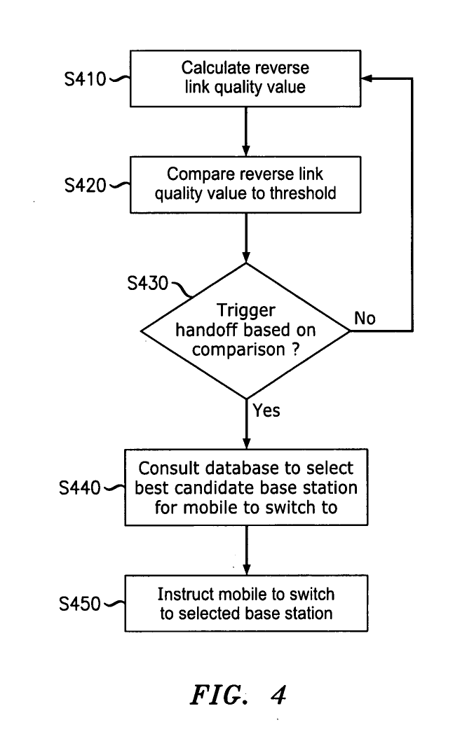

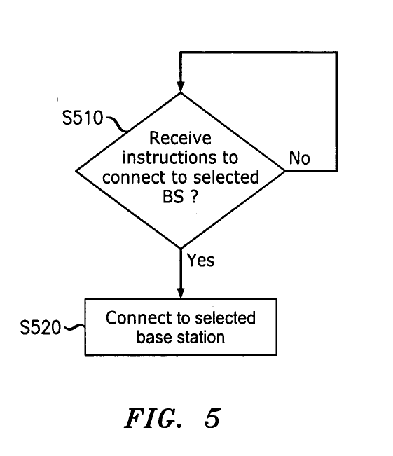

Methods for using reverse link quality measurements as a trigger for a DHO will now be discussed with reference to FIGS. 1, 4 and 5 using an example scenario in which the mobile device 130 transitions from communicating wirelessly with the first BS 110 using the first frequency f1 to communicating wirelessly with the second BS 120 using the second frequency f2, in FIG. 1. The example scenario mentioned above will first be discussed from the point of view of a network component with reference to FIG. 4. The example scenario mentioned above will then be explained from the point of view of a mobile device with reference to FIG. 5.

Referring to FIG. 1, the mobile device 130 has been in wireless communication with the first BS 110 and sending data to the first BS 110 via a reverse link between the mobile device 130 and the first BS 110 using the carrier signal of the first frequency f1. The BS 110 has been forwarding the data received from the mobile device 130 to the MSC 140 in the form of data frames.

FIG. 4 is a flow diagram illustrating a method of handling a DHO from the viewpoint of one or more network components. Referring to FIG. 4, in step S410 a reverse link quality value is calculated. Step S410 may be conducted in the same manner as step S210 illustrated in FIG. 2. In step S410, the MSC 140 calculates the reverse link quality value. As in step S210, in step S410 the MSC 140 can calculate the RFER based on data frames received by the MSC 140 from the first BS 110 as the reverse link quality value. The MSC 140 may calculate the AFSRFER based on the data frames selected by the frame selector 105 in the MSC 140 as the reverse link quality value. The MSC 140 may also calculate the average RFER of AFSRFER over a moving time window, for example 100 ms, as the reverse link quality value. Though the MSC 140 is described above as measuring the RFER or AFSRFER as the reverse link quality value, the MSC 140 can measure any known link quality metric associated with the reverse link as the reverse link quality value.

In step S420 the MSC 140 compares the reverse link quality value measured in step S410 to a threshold value. Step S420 may be conducted in the same manner as step S220 illustrated in FIG. 2. As in step S220, in step S420 if the measured reverse link quality value is an RFER or an average RFER, the threshold value is also an RFER, for example an RFER of 35%. The MSC 140 then generates a comparison result based on whether or not the measured reverse link quality exceeds the threshold value.

In step S430, based on the comparison result generated in step S420, the MSC 140 decides whether to trigger an inter frequency hand off operation for the mobile device 130. Step S430 may be conducted in the same manner as step S230 illustrated in FIG. 2. For example, as in step S230, in step S430 the MSC 140 may decide to trigger the hand off operation if the comparison result indicates that the average RFER exceeds the threshold RFER. As another example, the MSC 140 may decide to trigger the hand off operation if the comparison result indicates that the average RFER has exceeded the threshold RFER for more than a threshold period of time, for example 10s. If, based on the comparison result generated in step S420, the MSC 140 decides not to trigger the hand off operation, the method returns to step S410 and the MSC 140 continues to monitor the reverse link quality. If, based on the comparison result generated in step S420, the MSC 140 decides to trigger the hand off operation, the method proceeds to step S440. Though, for the purpose of simplicity, the process for triggering the inter frequency hand off operation is discussed above with reference only to the average RFER as the reverse link quality value, it will be understood that the same process may be implemented using any measured reverse link quality value including the average AFSRFER.

In step S440 the MSC 140 consults information stored within the MSC 140 to determine a base station to which the mobile device 130 to switch. The MSC 140 consults a table or a database stored within the MSC 140 including, for example, information regarding the frequencies and geographical location information of a plurality of BSs in wireless network 100. The MSC 140 then uses the stored information to select the best BS for the mobile device 130 to switch to based on the current geographical location of the mobile device 130. For example, the MSC 140 may select the BS that is physically closest to the current geographical location of the mobile device 130.

In step S450 the MSC 140 instructs the mobile device 130 to switch to the selected BS. For example, if the second BS 120 is the BS selected in step S260, the MSC 140 instructs the mobile device 130 to complete the DHO operation by discontinuing communicating wirelessly with the first BS 110 using the first frequency f1, and beginning communicating wirelessly with the second BS 120 using the second frequency f2. The MSC 140 may use any know method for instructing the mobile device 130 to complete a hand off operation between the first BS 110 to communicating with the second BS 120.

FIG. 5 is a flow diagram illustrating a method of handling a DHO from the viewpoint of a mobile device. Referring to FIG. 5, in step S510, the mobile device 130 determines whether instructions to switch from communicating with the first BS 110 using the first frequency f1 to communicating with the a BS selected by the MSC 140 have been received from the MSC 140. If instructions have not been received, the mobile device remains at step S510 and continues to wait for instructions. If instructions have been received, the mobile device proceeds to step S520. The BS selected by the MSC 140 is the BS that is determined by the MSC 140 to be the best candidate based on the consultation of the table or database stored in the MSC 140 in step S440, for example the second BS 120.

In step S520 the mobile device 130 discontinues communicating with the first BS 110 using the first frequency f1 and begins communicating with the a BS selected by the MSC 140, for example the second BS 120, completing the MAIFHO operation.

### Same Frequency Hard Handoff

Methods for using reverse link quality information to handle hand over operations according to the present invention are discussed above with respect to inter frequency hand off operations such as MAIFHO and DHO. However, methods for using reverse link quality information to handle hand over operations according to the present invention may also be applied to same frequency hard hand off (HHO) operations.

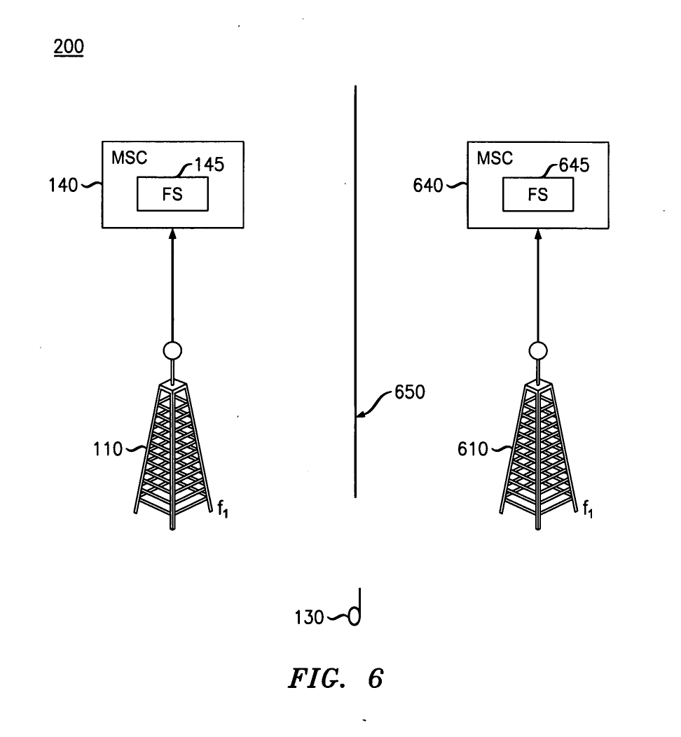

FIG. 6 illustrates a portion of a wireless network 200. Wireless system 200 includes the MSC 140, the first BS 110, a second MSC 640, a third BS 610 and the mobile device 130. The MSC 140, the first BS 110 and the second MSC 640 operate as discussed above with reference to FIG. 1. Though wireless system 200 is illustrated as having only one BS connected to the MSC 140, any number of BSs may be connected to the MSC 140.

The second MSC 640 may operate with third BS 610 in the same manner discussed above with respect to the MSC 140 and the first BS 110. The third BS 610 is connected to the second MSC 640 via a wired or wireless connection. The third BS 610 communicates wirelessly with mobile devices in wireless network 200 using a carrier signal of the same frequency as the first BS 110, first frequency f1. The carrier signal of the first frequency f1 supports wireless communication between the third BS 610 and mobile devices in wireless system 100 that are within range of the first BS 110. The third BS 610 may forward data received from mobile devices to the MSC 640 in the form of data frames. Though wireless system 200 is illustrated as having only one BS connected to the second MSC 640, any number of BSs may be connected to the second MSC 640.

As FIG. 6 illustrates, wireless network 200 includes a HHO boundary 650. HHO boundary 650 may represent a geographical boundary between the coverage area of the BSs connected to MSC 140 and that of the BSs connected to the second MSC 640. HHO boundary 650 may exist at, for example, a state border. As a mobile device operating in wireless network 200 approaches the HHO boundary 650, the MSC associated with the mobile device may detect a drop in the link quality of the mobile device. Based on the link quality of the mobile device, the MSC associated with the mobile device may instruct the mobile device to execute an HHO and begin communicating with a BS on the other side of the HHO boundary 650. According to the methods of the present invention, the MSC associated with the mobile device may use the reverse link quality value of the mobile device as a trigger for initiating the HHO.

For example, a scenario where mobile device 130 is in wireless communication with the first BS 110 and mobile device 130 approaches the HHO boundary 650 will now be discussed.

As mobile device 130 approaches the HHO boundary 650, the MSC 140 calculates the reverse link quality between mobile device 130 and the first BS 110. The MSC 140 compares the calculated reverse link quality to a threshold value. Based on the comparison, the MSC 140 determines whether or not to trigger an HHO operation. The MSC 140 can measure any known link quality metric associated with the reverse link as the reverse link quality value. The MSC 140 may use the same method discussed above with reference to step S230 illustrated in FIG. 2 to determine whether to trigger the HHO operation. For example, as is discussed above with reference to FIG. 2, the calculated reverse link quality value may be an average RFER or AFSRFER and the threshold value may be an RFER.

The MSC 140 may decide to trigger the HHO operation if the comparison of the average RFER to the threshold value indicates that the average RFER exceeds the threshold RFER. As another example, the MSC 140 may decide to trigger the hand off operation if the comparison result indicates that the average RFER has exceed the threshold RFER for more than a threshold period of time, for example 10s. Though, for the purpose of simplicity, the process for triggering the HHO operation is discussed above with reference only to the average RFER as the reverse link quality value, it will be understood that the same process may be implemented using any measured reverse link quality value including the average AFSRFER.

If the MSC 140 decides not to trigger the HHO operation, the MSC 140 continues monitoring the reverse link quality value of the mobile device.

If the MSC 140 decides to trigger the HHO operation, the MSC 140 instructs the mobile device 130 to complete a HHO operation and to switch from communication with the first BS 110 to communication with the third BS 610. The MSC 140 may use any know method for instructing the mobile device 130 to complete the HHO operation between the first BS 110 and the third BS 610.

Thus, according to the methods for handling a hand off operation using the reverse link quality values as triggers according to the present invention, a hand off operation can be triggered based on reverse link quality values in addition to forward link quality values. Accordingly, hand off operations can be triggered allowing the quality of service experienced by a user of a mobile device can be maintained at an acceptable level even in situations where a forward link quality of the mobile device is strong while a reverse link quality of the mobile device is weak.

The invention being thus described, it will be obvious that the same may be varied in many ways. Such variations are not to be regarded as a departure from the invention, and all such modifications are intended to be included within the scope of the invention.

What is claimed:

1. Method of handling handoff of a mobile device, the method comprising:
generating a first link quality metric based on a reverse link between the mobile and a first base station, the mobile device being in wireless communication with the first base station;
determining a first comparison result based on the link quality metric and a first threshold value;
based on the first comparison result,
selecting a second base station,
and instructing the mobile device to switch from communicating wirelessly with the first base station to communicating wirelessly with the second base station.

2. The method of claim 1, wherein the generating operation includes generating the link quality metric based on reverse frames received from the first base station at a mobile switching center (MSC) and selected by a frame selector included in the MSC.

3. The method of claim 2, wherein the first link quality metric includes an average reverse frame error rate (RFER) associated with the reverse link and the instructing operation includes instructing the mobile device to switch based on whether the RFER exceeds the threshold value, the average RFER being calculated over a moving window of time.

4. The method of claim 3, the instructing operation further includes instructing the mobile device to switch based on whether the RFER exceeds the threshold value for a reference period of time.

5. The method of claim 2, wherein selecting the second base station includes receiving link quality values for one or more candidate base stations from the mobile device at the MSC, and selecting a base station, from among the one or more candidate base stations, having a highest link quality value as the second base station.

6. The method of claim 2, wherein selecting the second base station includes referencing a database stored in the MSC and choosing a base station from among one or more candidate base stations as the second base station based on the database.

7. The method of claim 1, wherein the first base station uses a carrier signal of a first frequency, and the second base station uses a carrier signal of a second frequency different from the first frequency.

8. The method of claim 1, wherein the first base station and the second base station both use carrier signals of the same frequency.

9. The method of claim 1, further comprising:
generating a second link quality metric based on a forward link between the mobile and the first base station; and
determining a second comparison result based on the second link quality metric and a second threshold value, wherein
the selecting a second base station, and the instructing the mobile device to switch from communicating wirelessly with the first base station to communicating wirelessly with the second base station are further based on the second comparison result.

10. Method of handling handoff of a mobile device, the method comprising:
communicating wirelessly with a first base station;
receiving instructions to switch from communicating wirelessly with the first base station to communicating wirelessly with a second base station, the instructions being based on a link quality of a reverse link between the mobile and the first base station.

11. The method of claim 10, wherein the instructions are received at the mobile device from a mobile switching center (MSC).

12. The method of claim 11 further including:
receiving an indication from the MSC to conduct link quality measurements for one or more candidate base stations; and
conducting the link quality measurements for the one or more base stations and sending the measurements to the MSC,
wherein the second base station is a base station, from among the one or more candidate base stations, having a highest of the link quality measurements.

13. The method of claim 10, wherein the first base station uses a carrier signal of a first frequency, and the second base station uses a carrier signal of a second frequency different from the first frequency.

14. The method of claim 10, wherein the first base station and the second base station both use carrier signals of the same frequency.
